(19) United States
(12) Patent Application Publication
(10) Pub. No.: US 2009/0292745 A1
(43) Pub. Date: Nov. 26, 2009

(54) DATABASE MANAGEMENT SYSTEM AND METHOD

(75) Inventors: Ratnadeep Bose, Plainfield, IL (US); Jay S. Hakim, Northbrook, IL (US)

Correspondence Address: WILDMAN HARROLD ALLEN & DIXON LLP, 225 WEST WACKER DRIVE, SUITE 2800, CHICAGO, IL, 60606, US

(73) Assignee: ORBITZ WORLDWIDE, L.L.C., Chicago, IL (US)

(21) Appl. No.: 12/126,550

(22) Filed: May 23, 2008

(51) Int. Cl. G06F 17/30

(52) U.S. Cl. 707/204; 707/E17.001

(57) ABSTRACT

A database management system and method is provided. In one example, the database management system may include a first type of source database, a second type of source database, a target database, and a replication system operable to replicate at least one of structure and data from either the first source database or the second source database to the target database. In another example, the source database may include a first table having a first configuration and a second table having a second configuration, and a first data record in the first table and a second data record in the second table. The replication system may include a data replication component adapted to identify both the first and second data records from the first and second tables having different configurations and replicate the first and second data records to the target database.

### FIELD OF THE INVENTION

The present invention generally relates to database management systems and methods and, more particularly, to database management systems and methods for replicating data and structure from a source database to a target database.

### BACKGROUND

It is often important to store the same data in multiple databases. The duplication of data may be required for a variety of reasons. For example, duplication may be needed to improve the availability of the data or for security reasons. Additionally, data may be duplicated from one database to another database to allow each database to be utilized for a different purpose.

A database can have multiple users utilizing the database for various reasons. Some users of the database may need real-time access to the data stored in the database and typically request relatively small amounts of data, which can be retrieved in relatively small amounts of time. Other users of the database may require large amounts of data for analysis purposes. Utilizing large amounts of data and analyzing the data typically monopolize a large portion of database resources, which would impinge upon real-time access to the database by other users.

Furthermore, database platforms may be designed to suit a specific purpose. However, duplicating data between multiple databases raises the issue of how to keep multiple copies of data consistent.

In order to maintain separate and duplicate databases, each database must be kept consistent with regards to its structure and the data it holds. Some databases are updated frequently as new records are added, modified, and deleted. Additionally, the structure of the database may change to accommodate new types of information or to rearrange the organization of information. As a result, database tables and table columns may be added, modified, or deleted. These structural changes must also be replicated in all of the databases which aim to duplicate the data.

The process of replicating structure and data of a database involves recognizing the changes made in one database and making the same change in another database. For example, if new records have been added to one database table, those new records must also be added to the duplicate of that table in another database. Similarly, if a new column is added to a table in one database, that column must also be added to the duplicate table in another database. However, this duplication can be time consuming and complicated where thousands of data and structural updates are necessary across multiple databases.

As a result, various tools have been developed to assist in this process. Some tools are only useful for replicating data from a source database to a target database where both databases have the same platform. Other tools that allow the replication of data between databases of different platforms are not always capable of additionally replicating the database structure. These tools can only replicate the data, and any structural changes must be made manually. The more manual changes that are required, the more time it takes to complete the replication process. Manual changes also increase the likelihood that an error in the structural updates will occur, thereby further prolonging the time it takes to complete the replication. Many of the tools described above must also utilize an intermediate storage location to hold the data while it is in transition from a source database to a target database. This intermediary further complicates the process by introducing yet another element that must be maintained.

Therefore, a need exists for a near-real time, automated system for replicating data and structural changes, independent of database platform and without substantial overhead requirements.

### BRIEF DESCRIPTION OF THE DRAWINGS

FIG. 1 is a diagram of an exemplary database management system.

FIG. 2 is a schematic of a set of source and target databases prior to structural replication.

FIG. 3 is a schematic of the set of source and target databases shown in FIG. 2 after structural replication.

FIG. 4A is a schematic of a source database prior to data replication.

FIG. 4B is a schematic of a target database associated with the source database shown in FIG. 4A, the target database shown prior to data replication.

FIG. 5A is a schematic of the source database shown in FIG. 4A, the source database shown after data replication.

FIG. 5B is a schematic of the target database shown in FIG. 4B, the target database shown after data replication.

FIG. 6 is a block diagram of an exemplary replication system of the database management system.

FIG. 7 is a flowchart of an exemplary configuration process of an exemplary replication system.

FIG. 8 is a system diagram illustrating an example of structural replication employed by the database management system.

FIG. 9 is a flowchart of a first embodiment of a structural replication process.

FIG. 10 is a flowchart of a second embodiment of a structural replication process.

FIG. 10A is a flowchart of a portion of the structural replication process shown in FIG. 10.

FIG. 11 is a flowchart of a check process performed in the structural replication process shown in FIG. 10.

FIG. 12 is a system diagram illustrating an example of data replication employed by the database management system.

FIGS. 13-16 are flowcharts of an exemplary data replication process.

FIG. 17 is a schematic of a source database including a first table and a deleted records table, the first table including a create date column and a modified date column.

FIG. 18 is a schematic of a target database associated with the source database shown in FIG. 17, the target database including a table having a create date column, a modified date column, and a deleted time stamp column.

FIG. 19 is a schematic of a set of source and target databases and multiple queues between the source and target databases for data replication purposes.

FIG. 20 is an exemplary flowchart of a process associated with FIG. 19.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

In one example, a database management system is provided and includes a first source database comprising a first type of database, the first source database including structure and data, the structure comprising a first table and the data comprising a first data record in the first table. The database management system also includes a second source database comprising a second type of database different than the first type of database, the second source database including structure and data, the structure comprising a second table and the data comprising a second data record in the second table. Further, the database management system includes a target database and a replication system including at least one of a structural replication component adapted to replicate structure and a data replication component adapted to replicate data, the replication system being operable to replicate at least one of structure and data from either the first source database or the second source database to the target database.

In another example, a database management system is provided and includes a source database comprising one of a plurality of source database types, the source database including structure and data, the structure comprising a table and the data comprising a data record in the table. The database management system also includes a target database comprising one of a plurality of target database types and a replication system including at least one of a structural replication component adapted to replicate structure and a data replication component adapted to replicate data, the replication system communicates with the source database when the source database is any one of the plurality of source database types and communicates with the target database when the target database is any one of the plurality of target database types to replicate at least one of structure and data from the source database to the target database.

In these examples, the database management system may replicate either structure or data from a source database to a target database no matter the type of source database and target database. In other words, the database management system replicates independently of the type(s) of source and target databases.

In yet another example, a database management system is provided and includes a source database including source structure and source data, the source structure comprising a first table having a first configuration and a second table having a second configuration different than the first configuration, the source data comprising a first data record in the first table and a second data record in the second table. Also, the database management system includes a target database and a replication system including a data replication component adapted to identify both the first and second data records from the first and second tables having different configurations and replicate the first and second data records to the target database. In such an example, the database management system may replicate data from tables within the source databases that have different configurations.

In a further example, a database management system is provided and includes a source database including source data and a target database including target data, wherein a difference in data exists between the source data and the target data, and wherein the difference in data is one type of a plurality of types of differences. The database management system also includes a replication system including a data replication component adapted to create a data element based on the type of difference in data between the source data and the target data, wherein the data replication component applies the data element to the target database to change the target data such that the difference in data no longer exists between the source data and the target data. In such an example, the database management system may replicate a variety of different types of data changes from the source database to the target database. For example, the database management system may replicate newly created records, updated records, or deleted records from the source database to the target database.

A system and method are provided for replicating both data and database structure from a source database to a target database. In one embodiment, the system is configured to replicate data and structure from transactional databases (source) to non-transactional databases (target) in connection with establishing travel itineraries. In such embodiments, information stored in the databases can relate to airlines, rental cars, hotels, travel insurance, etc.

In an example where the databases are airline databases, the airline transactional database frequently receives new, updated, or cancelled data and structure from a variety of locations including, but not limited to, airline reservation systems, and global distribution systems (GDS) such as ITA and Worldspan., etc. From time to time, it may be valuable to replicate (or copy) the new, updated, or deleted data and structure from the airline transactional database to the airline non-transactional database. Such replicated data and structure must be replicated quickly and accurately to ensure that the airline non-transactional database is similar in data and structure to the airline transactional database.

Data and structure may be replicated from the transactional databases to the non-transactional databases for a variety of reasons. For example, transactional databases are utilized by many users, particularly when used with an on-line application, and a business managing the transactional databases may wish to analyze transactions on the transactional databases or run a report on the transactional databases. Performing analysis or running reports on the transactional databases can drastically and negatively impact performance of the transactional databases, thereby drastically and negatively impacting the capability of users to perform transactions on the transactional databases. To reduce the negative impact of performance on the transactional databases, data and structure from the transactional database is replicated to the non-transactional database and the business entity can run as much analysis and as many reports on the non-transactional databases as desired without negatively impacting performance of the transactional databases.

Prior to describing the following exemplary system and method, it should be understood that the system and method may be applied to replication of data and structure from source databases to target databases for a wide variety of applications such as, for example, travel itineraries, financial systems, packaged goods point-of-sale transactions, on-line activity, or any other business actively utilizing databases, and not just for the application(s) described and illustrated herein. Accordingly, the following description and figures are not intended to be limiting.

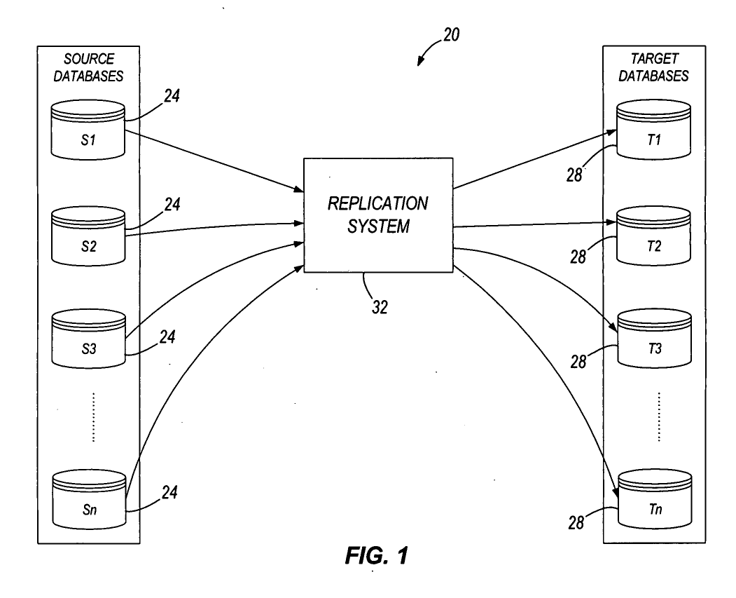

Referring to FIG. 1, an exemplary block diagram of a database management system 20 is illustrated. The database management system 20 is configured to replicate both data (e.g., new customer records, purchased itineraries, etc.) and structure (e.g., new tables, new columns added to existing tables, etc.) within the databases from source databases 24 (S1, S2, S3, . . . , Sn) to target databases 28 (T1, T2, T3, . . . , Tn). The database management system 20 may include any number of source databases 24 and target database 28. As seen in FIG. 1, each source database 24 generally has a corresponding target database 28. In the example seen in FIG. 1, the database management system 20 includes a replication system 32, a plurality of source databases 24, and a plurality of target databases 28. In some embodiments, each of the source and target databases 24, 28 is included in an individual server. Alternatively, any number of the source databases 24 can be comprised in a single server and any number of the target databases 28 can be comprised in a single server. Also, in the alternative, any number of the source and target databases 24, 28 can be comprised in a single server.

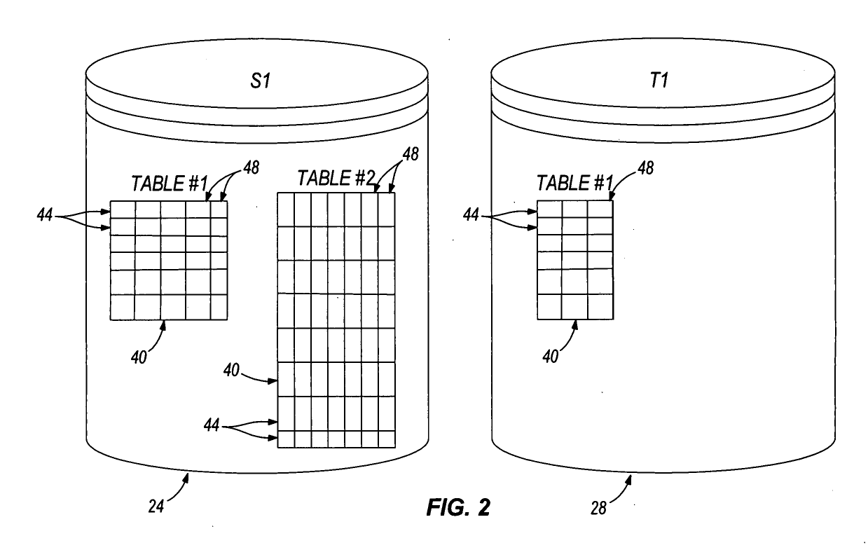

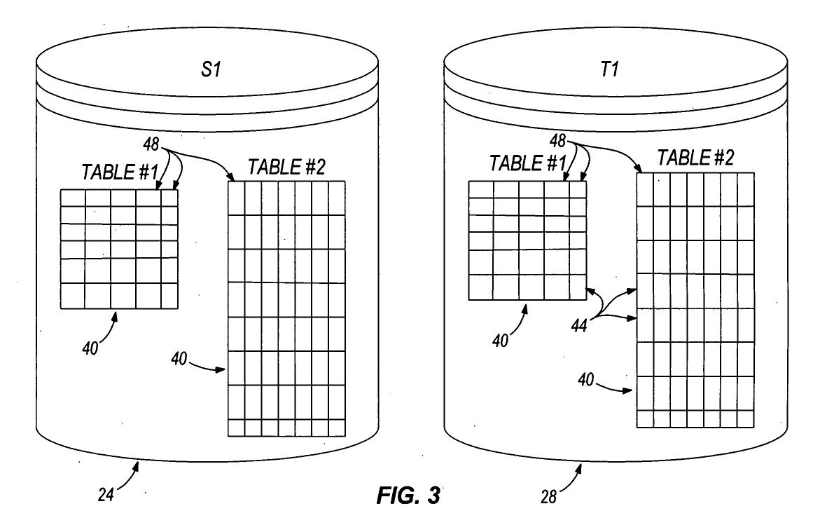

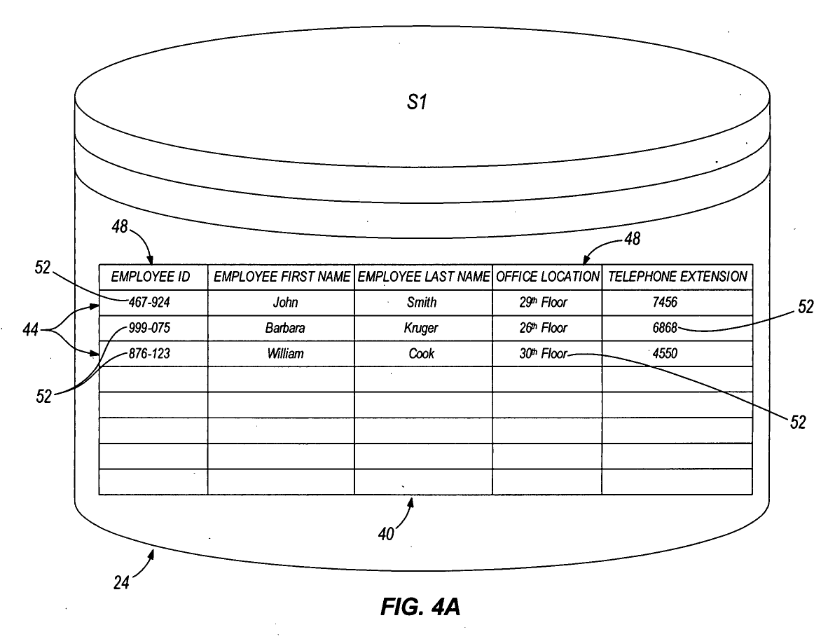

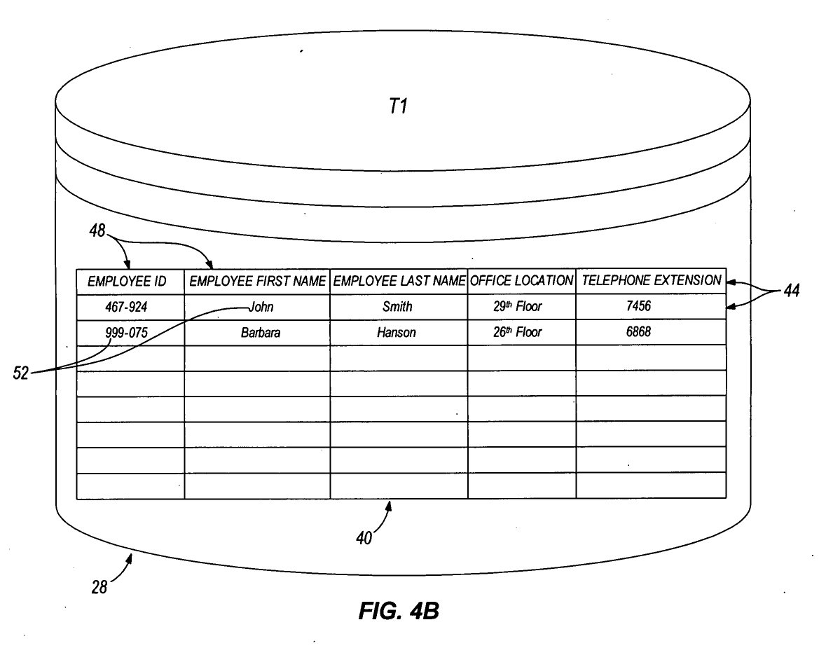

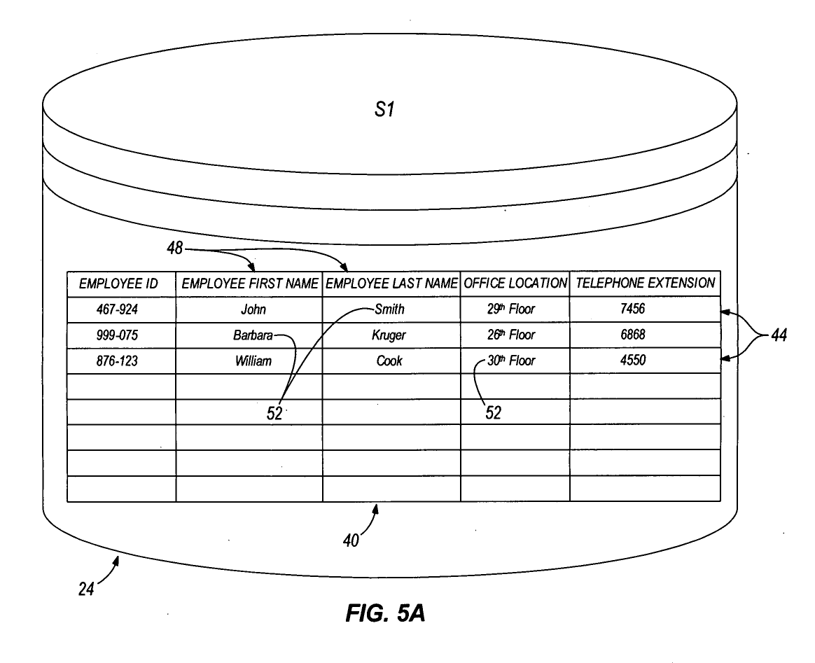

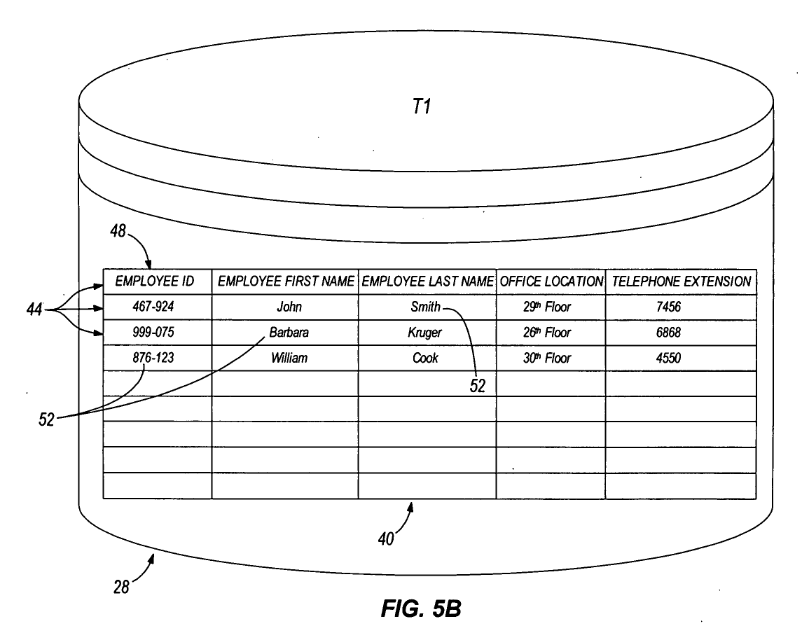

Referring now to FIGS. 2-5, sets of source and target databases 24, 28 are illustrated. The structure within source and target databases 24, 28 typically comprises tables 40 having rows 44 and columns 48, while the data within the source and target databases 24, 28 typically comprises records 52 (see FIGS. 4A-5B) stored within the rows 44 and columns 48 of the tables 40. With particular reference to FIG. 2, a single set of source and target databases 24, 28 is shown with the source database 24 having a structural change performed therein and the structural change not yet replicated to the corresponding target database 28. More particularly, the source database 24 includes Table #1 having five columns 48 and six rows 44, and Table #2 having seven columns 48 and eight rows 44. The target database 28 only includes Table #1, which has three columns 48 and six rows 44. Turning now to FIG. 3, the same set of source and target databases 24, 28 is shown after the structure from the source database 24 is replicated to the target database 28. Table #1 in the target database 28 was structurally altered by adding two more columns 48 to bring Table #1 to a total of five columns 48, thereby equaling the number of columns 48 in Table #1 of the source database 24. Also, new Table #2 was created in the target database 28 to provide the target database 28 with the same structure as the source database 24.

FIGS. 4A and 4B respectively illustrate a set of source and target databases 24, 28 prior to data replication. The source database 24 includes a data change that has not yet been replicated to the target database 28. More particularly, the record 52 associated with the employee named “Barbara Kruger” has been modified to change her last name from “Hanson” to “Kruger”. This data change has occurred in the source database 24, but has not been replicated to the target database 28 as exemplified in FIG. 4B by the record 52 still listing “Hanson” as the last name. Also, the record 52 associated with the employee “William Cook” has been created in the source database 24, but has not yet been replicated to the target database 28 as exemplified in FIG. 4B by the absence of the record in the target database 28. Turning now to FIGS. 5A and 5B, the same set of source and target databases 24, 28 is shown after the data from the source database 24 is replicated to the target database 28. More particularly, the record 52 in the target database 28 associated with the employee named “Barbara Kruger” has been replicated by changing her last name from “Hanson” to “Kruger”. Also, the record 52 in the target database 28 associated with the employee named “William Cook” has been replicated by creating the record 52 in the target database 28.

It should be understood that the data and structure, and associated replication, described herein and illustrated in FIGS. 2-5 are presented by way of example only in order to assist with understanding of data replication and structural replication. In no way should these provided examples be considered limiting. Instead, the database management system 20 is capable of replicating a large variety of data types and structural types from source databases to target databases.

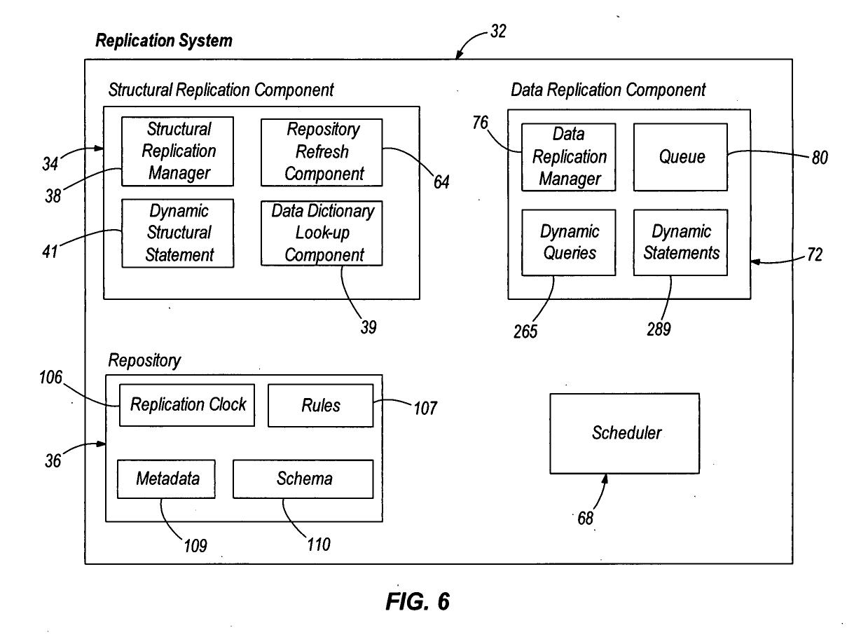

With reference to FIG. 6, the replication system 32 and its components are illustrated. The replication system 32, in this example, includes a structural replication component 34, a repository 36, a scheduler 68, and a data replication component 72. The structural replication component 34 is responsible for performing the structural changes to the target database 28 to bring the source and target databases 24, 28 into agreement. The structural replication component 34 includes a structural replication manager 38, a data dictionary look-up component 39, a dynamic structural element or statement 41, and a repository refresh component 64. The structural replication manager 38 manages and performs various tasks associated with structural replication, the data dictionary look-up component 39 is responsible for opening data dictionaries in each of the source and target databases 24, 28, the repository refresh component 64 is responsible for identifying structural differences between the source and target databases 24, 28, and the dynamic structural statement is capable of making the structural changes to the target database 28, all of which will be described in greater detail below. The data replication component 72 is responsible for identifying data differences between the source and target databases 24, 28, and performing the data changes to the target database 28 to bring the source and target databases 24, 28 into agreement. The data replication component 72, in this example, includes a data replication manager 76 for managing and performing various tasks associated with data replication, a queue 80 for assisting with organizing the data to be replicated, dynamic queries 265 for assisting with identifying data differences between the source and target databases 24, 28, and dynamic elements or statements 289 for assisting with making the data changes to the target database 28. The scheduler 68 communicates with the structural replication component 34 and the data replication component 72 to respectively initiate structural and data replication. The repository 36, in this example, includes a replication clock 106, rules, 107, metadata 109, and schema 110, all of which will be described in greater detail below.

The database management system 20 of FIG. 1 executes several different processes, which will be generally described herein with a more specific description of each process to follow. The database management system 20, for example, performs a configuration process, a structural replication process, and a data replication process. Alternatively, the database management system 20 can include more or fewer processes. Regarding the configuration process, the database management system 20 can be configured by a user according to the requirements and specifications of the user relating to a particular application in which the database management system 20 is used. Since the database management system 20 may be utilized in many different types of applications, the database management system 20 is adapted to be configured in many different manners. After the database management system 20 is appropriately configured, the database management system 20 can execute a structural replication process via the structural replication component 34, FIG. 6. Generally, during the structural replication process, the repository refresh component 64 identifies structural differences between the source databases 24 and the target databases 28, refreshes or updates the repository 36 with the results of the repository refresh process, and the structural replication component 34 replicates the structural differences to the target databases 28 to bring the source databases 24 and the target databases 28 into agreement. An exemplary structural replication process will be described below in greater detail. After the structure of the source and target databases 24, 28, FIG. 1, are brought into agreement in the structural replication process, the database management system 20 performs a data replication process via the data replication component 72, FIG. 6, of the replication system 32 to replicate data from the source databases 24 to the target databases 28, which will also be described in greater detail below.

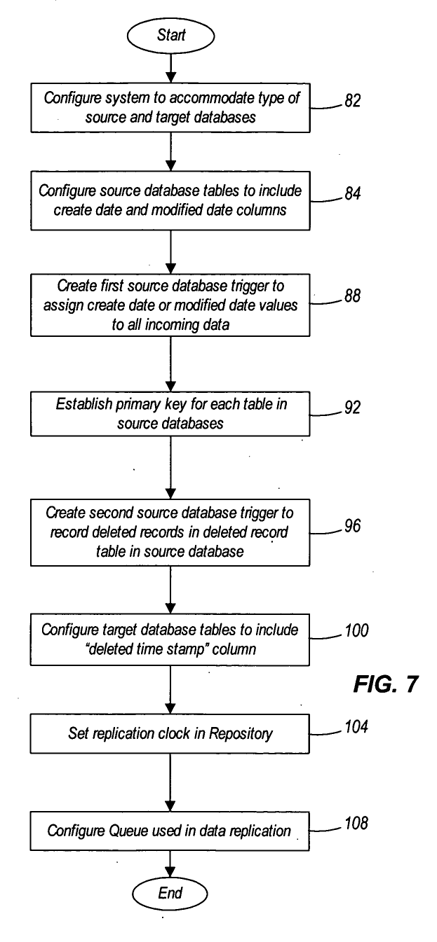

Referring now to FIG. 7, an exemplary manner of configuring the database management system 20 will be described in greater detail. It should be understood that this is only one of many different manners of configuring the database management system 20 and such description should not be considered limiting. System configuration depends on the application in which the database management system 20 is incorporated and the desires of the user performing the configuration.

At step 82, it is important that the replication system 36 know the type of source and target databases 24, 28 it is interacting with in order to facilitate communication with the source and target databases 24, 28. Accordingly, the database management system 20 is configured to accommodate the type of source and target databases 24, 28. The database management system 20 is configured differently for different types of source and target databases 24, 28. As is well understood in the art, many types of databases and database manufactures exist. For example, various types of databases include Oracle, DB2, Sybase, SQL Server, MySQL, Teradata, etc. In some embodiments, the source and target databases 24, 28 can be the same type of database. In other embodiments, the source and target databases 24, 28 are different types of databases. Either way, the database management system 20 can be properly configured to communicate with the databases.

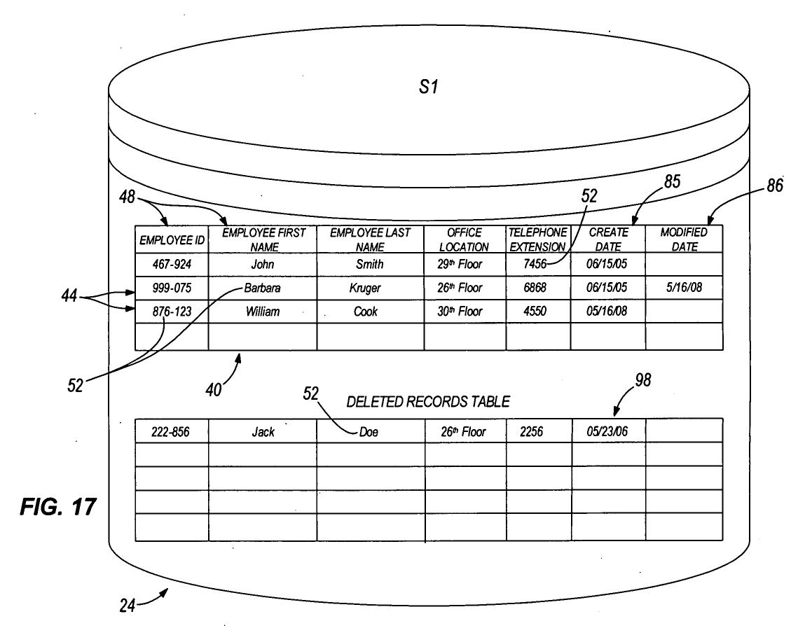

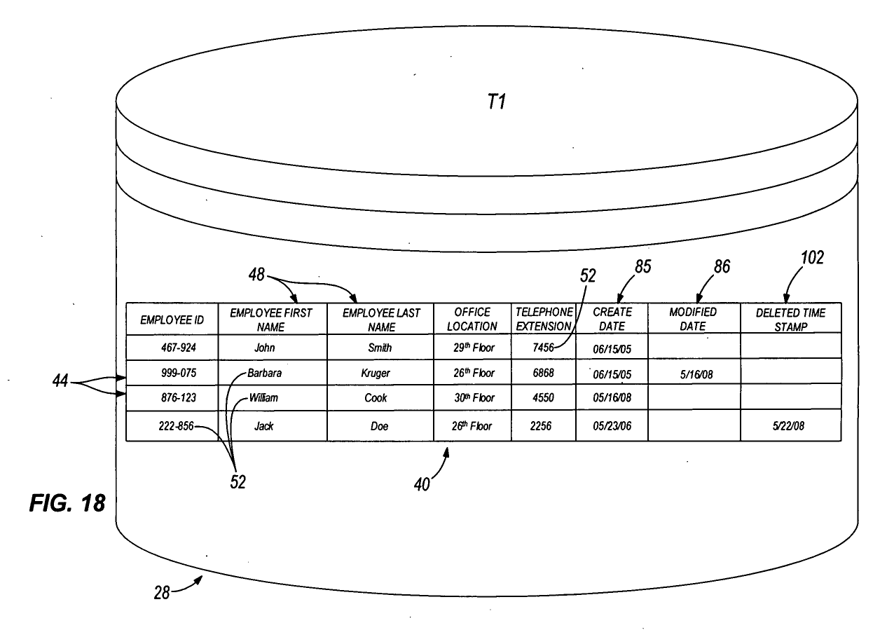

At step 84, the source databases 24 are configured by a user to comply with the demands of the application in which they will be used. Configuration of the source databases 24 can include, for example, establishing table sizes, table content, columns, data types, default values, etc., within each of the source databases 24. In the illustrated embodiment, the tables of the source databases 24 are configured to include a “create date” column 85 and a “modified date” column 86. The create date is the date on which a record was created and is stored in the “create date” column 85 of the table (see FIGS. 17 and 18). Modification of a record may occur after creation of the record. The modified date is the date on which a record was last modified, and is stored in the “modified date” column 86 of the table (see FIGS. 17 and 18).

At step 88, FIG. 7, a user creates a first source database trigger on each table in the source database 24. A trigger is generally a set of instructions carried out upon the occurrence of an event. In the illustrated embodiment, the first source database trigger assigns a create date or a modified date to all data entering into the source databases 24. For example, if a new data record is entering the source database 24, the first source database trigger will determine the create date and time of the new data record and populate the “create date” column 85 (see FIG. 17) of the table 40 associated with the new data record 52 with the created date and time. Also, for example, if a data record in an existing row in a table of the source database 24 is modified, then the first source database trigger populates the “modified date” column 86 (see FIG. 17) of the table 40 associated with the modified data record 52 with the date and time in which the data record was modified.

At step 92, a user assigns a primary key to each table in the source databases 24 to assist with data replication. The primary key assists in identifying records that have been modified or deleted (described in greater detail below). In some embodiments, the primary key may be items such as social security numbers, itinerary confirmation codes or IDs, a customer ID, other sequentially established data creating uniqueness between records, or other unique information that distinguishes the numerous data records. For example, and with reference to FIG. 17, the primary key may be the employee ID since this data is unique between all records 52. At step 96, a user creates a second source database trigger on each table in the source databases 24 to record the date and time of records deleted from the source databases 24, FIG. 1, in a deleted records table 98 (see FIG. 17) present in each of the source databases 24. Data records 52 are often deleted from source databases 24. When the replication system 32 needs to replicate a deleted data record from the source database 24 to a target database 28, the replication system 32 needs to have the ability to identify which records have been deleted. Accordingly, when a record is deleted, the second source database trigger activates to store the deleted record in the deleted records table 98. When the replication system 32 is ready to replicate the deleted record, the replication system 32 looks in the deleted record table for the deleted records (described in greater detail below). In this example, each source database 24 includes its own deleted records table 98 for storing deleted records.

Target databases 28, FIG. 1, may also require configuration depending on the application. At step 100, FIG. 7, a user configures each table of the target databases 28 to include a “deleted time stamp” column 102 (see FIG. 18). During data replication, deleted records are identified in the source databases 24 (i.e., the deleted records table 98) and it is desirable to delete the associated records from the corresponding target database 28. In some embodiments, the records are completely deleted from the target database 28. In other embodiments, including the illustrated embodiment, the records are not completely deleted, but instead are maintained in the target database 28. In addition to maintaining the deleted records in the target database 28, the “deleted time stamp” column 102 is populated with the date on which the record was deleted. Maintaining the deleted record in the target database 28 ensures that the data will not be lost permanently and is valuable in the event the data records need to be restored. Also, deleted records may be maintained for auditing reasons, to satisfy compliance regulations, or to provide the managing business entity with the capability to identify the deleted records and determine why the records were deleted.

At step 104, a user configures the repository 36 by setting a replication clock 106 (see FIG. 6). Upon initial operation of the database management system 20, the replication system 32 must have an initial date and time to begin looking for records to replicate in the source databases 24. In this example, the replication clock 106 may be set at a date and time earlier than the earliest date and time of all records in the source databases 24. That way, all records in the source databases 24 can be identified and replicated. After the database management system 20 completes a replication, the replication clock 106 is reset with the date and time of the last completed replication. This ensures that the next time the database management system 20 runs, the replication system 32 will begin looking for those records created, updated, or deleted since the last replication of the database management system 20.

At step 108, FIG. 7, the queue 80, FIG. 6, requires configuration in order to handle the data and structure replication from the source databases 24 to the target databases 28. In some embodiments, the database management system 20 includes one queue 80 for each set of source and target databases 24, 28. Alternatively, a single queue 80 can accommodate multiple sets of source and target databases 24, 28 or multiple queues 80 can be utilized with a single source or target database 24, 28. The queue 80 must be configured to include the appropriate structure for receiving the replicated data records on their way to the target database 28. During operation, the structure of the source and target databases 24, 28 may change and, accordingly, the structure of the queue 80 must also change to accommodate the changes in the source and target databases 24, 28. As indicated above, the changes in structure are identified by the repository refresh component 64 during the structural replication process and these changes are performed by the structural replication component 34 upon completion of the structural replication process. In some embodiments, a user initially configures the queue 80 with a beginning structure and the structure of the queue 80 is changed by the structural replication component 34 upon completion of the structural replication process (described in more detail below). In other embodiments, the structure of the queue 80 is initially established by the structural replication component 34 after completion of the first structural replication process. In these embodiments, the structural changes are stored or refreshed in the repository 36 and the structural replication component 34 performs these stored structural changes to the queue 80.

It should be understood that the illustrated and described order of configuration steps is merely exemplary and the steps can be performed in a variety of different orders. Also, it should be understood that the database management system 20 can be configured in a variety of different manners to include, for example, any number of the illustrated configuration steps, or more or less configuration steps than illustrated.

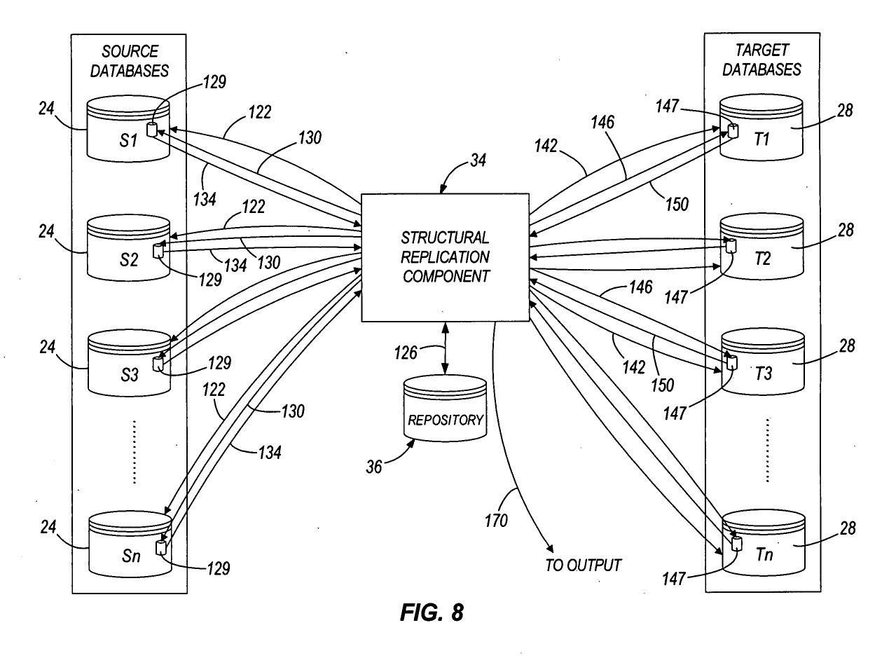

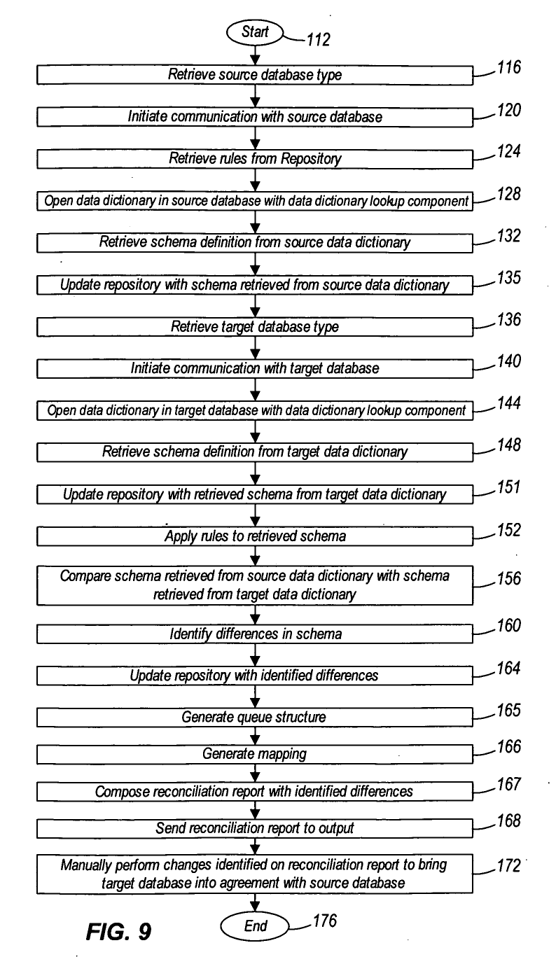

Referring now to FIG. 8, a general system diagram illustrating a structural replication process performed by the structural replication component 34 is shown. In addition to FIG. 8, reference is also made to FIG. 9, which is a flowchart identifying steps of a first embodiment of the structural replication process. The structural replication component 34 may, for example, perform the structural replication process on all source databases 24 and target databases 28. The repository refresh component 64 is responsible for identifying the structural changes that have occurred to the source databases 24, but have not yet been replicated to the target databases 28. In other words, the repository refresh component 64 identifies the structural differences between the source databases 24 and the target databases 28. After the structural differences are identified, the structural replication component 34 updates the repository 36 with the identified structural differences. The structural replication component 34 replicates structure from the source databases 24 to the target databases 28 once the structural differences have been identified by the repository refresh component 64. The structural replication component 34 performs the structural replication process similarly with each set of source and target databases 24, 28. Accordingly, the structural replication process will be described herein with respect to only one set of source and target databases 24, 28.

The structural replication component 34, FIG. 8, begins the structural replication process at step 112, FIG. 9. The structural replication process can be initiated in a variety of manners. In some embodiments, the scheduler 68 initiates the structural replication process by communicating with the structural replication component 34. The scheduler 68 can be set to initiate a structural replication process at any time interval. For example, the scheduler 68 can be set to initiate a structural replication process every second, hour, month, year, or any other time interval in between those listed or any time interval greater than a year. Alternatively, the scheduler 68 can initiate structural replication on a real-time basis. That is, the scheduler 68 initiates a structural replication process instantly each time a source database 24 receives new, modified, or deleted structure to replicate the structure to the target database 28. In such an alternative, a scheduler 68 may not be required. Instead, the structural replication component 34 will detect when a structure change has occurred in the source database 24 and automatically begins the structural replication process upon detection of the structure change. In other embodiments, the structural replication process can be initiated manually. In such embodiments, a user decides when a structural replication process should be run and then initiates a structural replication process.

At step 116, the structural replication component 34 retrieves the type of source database 24. The database management system 20 was configured at step 82 with the type of source database 24. The type of source database 24 is retrieved at this point so the structural replication component 34 knows how to communicate with the source database 24. If the structural replication component 34 did not retrieve the type of source database 24, it may not be able to communicate with the source database 24. Once the type of source database 24 is retrieved, the structural replication component 34 initiates communication with the source database 24 at step 120 and as identified by arrow 122 in FIG. 8. At step 124, FIG. 9, the structural replication component 34 retrieves rules 107 from the repository 36 as represented by arrow 126. A user may configure rules 107 into the repository 36 to refine the data and/or structure that will be replicated. For example, a user may configure inclusion and exclusion rules 107 into the repository 36 in order to refine the data and/or structure necessary for a particular application. Rules 107 can apply at a variety of levels including, but not limited to, databases, tables, columns, or records (i.e., data). Alternatively, rules 107 may not be applied if a user does not wish to refine data and structure. At step 128, the data dictionary look-up component 39 of the structural replication component 34 opens the data dictionary 129 in the source database 24 as represented by arrow 130 in FIG. 8. Each source database 24 includes a data dictionary 129, which is a small database or catalog within the source database 24 that includes the structure within the source databases (e.g., list of tables, list of columns that make up each table, size of tables and columns, data types within the tables, or any other information about or constraint of the source database). The data dictionary look-up component 39 is specially designed to look into data dictionaries of the databases. At step 132, the structural replication component 34 retrieves schema definition from the source data dictionary 129 as represented by arrow 134 in FIG. 8. The schema definition includes the current structure within the source database 24. At step 135, the structural replication component 34 updates the repository 36 with the retrieved schema 110.

With continued reference to FIG. 9, the structural replication component 34 retrieves the type of target database 28 at step 136. Similar to retrieving the type of source database 24, it is desirable that the structural replication component 34 know what type of database it is dealing with in order to properly communicate with the target database 28. At step 140, the structural replication component 34 initiates communication with the target database 28 as represented by arrow 142 of FIG. 8. The data dictionary look-up component 39 opens the data dictionary 147 in the target database 28 at step 144 as represented by arrow 146. Similar to the source data dictionary 129, each target database 28 includes a data dictionary 147, which is a small database or catalog within the target database that includes the structure within the target databases 28 (e.g., list of tables, list of columns that make up each table, size of tables and columns, data types within the tables, or any other information about or constraint of the source database). At step 148, the structural replication component 34 retrieves schema definition from the target data dictionary 147 as represented by arrow 150 in FIG. 8. Similar to the source schema definition, the target schema definition includes the current structure within the target database 28. At step 151, the structural replication component 34 updates the repository with the schema 110 retrieved from the target database 28. At step 152, the structural replication component 34 applies the earlier retrieved rules 107 to the schema 110 retrieved from both the source and target data dictionaries 129, 147 and located in the repository 36. These rules 107 are applied in order to refine the schema 110 to an extent desired by the user. The structural replication component 34 then compares the refined schema from the source and target data dictionaries 129, 147 at step 156 to identify any differences (step 160) that may exist between the schema of the source and target databases 24, 28.

The structural replication component 34 now updates the repository 36 at step 164 with the schema differences identified at step 160. At step 165, the structural replication component 34 generates the structure of the queue based on the structural differences identified and updated in the repository 36. As described above, the queue 80 needs to have the same structure as the source and target databases 24, 28 in order to be able to accommodate the data replication that will be occurring later. Accordingly, the structural replication component 34 looks in the repository 36 to see what structural changes were made to the source database 24 and will be made to the target database 28, and makes the structural changes to the queue 80.

At step 166, the structural replication component 34 generates mapping based on the structural differences identified and updated in the repository 36. Mapping is required between the source database 24 and the target database 28 to enable data replication between the source and target databases 24, 28. As the structure of the source and target databases 24, 28 changes, so must the structure of the mapping in order to handle the data being replicated between the source and target databases 24, 28. As described above, the queue 80 needs to have the same structure as the source and target databases 24, 28 in order to be able to accommodate the data replication that will be occurring later. Accordingly, the structural replication component 34 looks in the repository 36 to see what structural changes were made to the source database 24 and will be made to the target database 28, and makes the structural changes to the queue 80.

At step 167, the structural replication component composes a reconciliation report that will include the structural differences identified at step 160. At step 168, the structural replication component 34 sends the reconciliation report to an output as represented by arrow 170 in FIG. 8. The reconciliation report can be sent in a variety of formats including, but not limited to, email, SNMP trap, etc., and includes the schema differences identified at step 160. In some embodiments, the output to which the reconciliation report is sent can be a programmer, data architect, database administrator, other users, or a computer memory or database for storage.

At this point of the structural replication process, structural replication is ready to be performed. In the illustrated embodiment and at step 172, the network manager, programmer, or other user manually performs the structural replication to make the schema or structure changes to the target database 28 to bring the target database 28 into agreement with the source database 24. In other words, the schema or structural differences identified in the reconciliation report are made to the target database 28 by a user to bring the structure of the source and target databases 24, 28 into agreement. With the manually performed structural replication complete at step 172, the structural replication process ends at step 176.

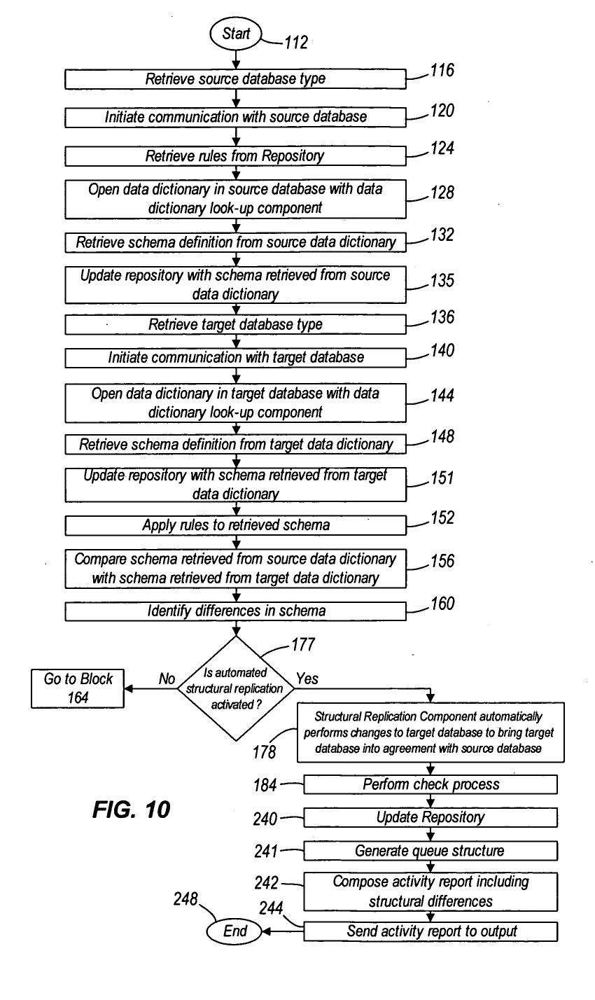

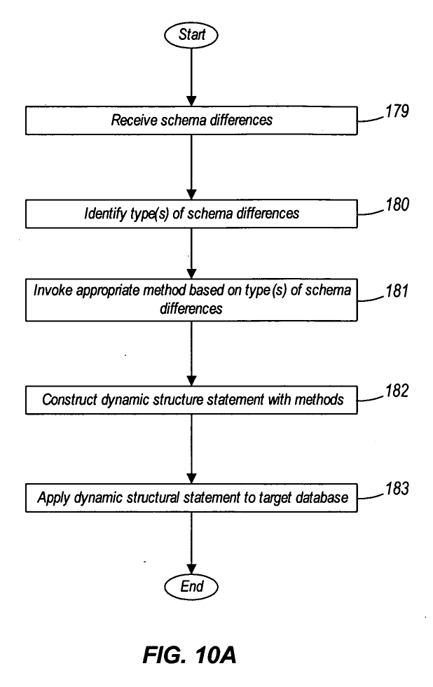

Referring now to FIG. 10, a flowchart identifying steps of an alternative embodiment of a structural replication process preformed by the structural replication component 34 is illustrated. Reference is also made to the general system diagram of FIG. 8 illustrating the structural replication component 34 interacting with the source and target databases 24, 28 and the repository 36. Similar to the embodiment of the structural replication process illustrated in FIG. 9, the structural replication process illustrated in FIG. 10 is performed by the structural replication component 34 on the source databases 24 and target databases 28, and the repository refresh component 64 of the structural replication component 34 is responsible for identifying the structural changes that have occurred to the source databases 24, but have not yet been replicated to the target databases 28. In this embodiment of the structural replication process, the structural replication component 34 is also responsible for automatically performing structural replication from the source databases 24 to the target databases 28 once the structural differences have been identified by the repository refresh component 64. The structural replication component 34 performs the structural replication process similarly with each set of source and target databases 24, 28. Accordingly, the structural replication process will be described herein with respect to only one set of source and target databases 24, 28.

The alternative embodiment of the structural replication process illustrated in FIG. 10 is similar to the first embodiment of the structural replication process illustrated in FIG. 9 from step 112 to step 160. Accordingly, the common steps are assigned similar reference numbers and will not be described again herein. The structural replication process illustrated in FIG. 10 differs after the differences in structural schema are identified at step 160. Rather than the structural replication component 34 updating the repository 36 at this point with the identified schema differences, the structural replication component 34 determines if automated structural replication is activated by a user at step 177. If automated structural replication is not activated, the structural replication process proceeds to step 164 of FIG. 9 where the structural replication component 34 performs steps 164 to 168, as described above, and the structural replication is carried out manually. If automated structural replication is activated, the structural replication component 34 performs the structural replication of schema or structure to the target database 28 to bring the target database 28 into agreement with the source database 24 at step 178. In other words, the structural replication component 34 makes the schema or structural differences identified at step 160 to the target database 28 to bring the structure of the source and target database 24, 28 into agreement. The structural replication component 34 automatically performs the structural replication without any interaction from a user.

Referring now to FIG. 10A, the automated structural replication performed at step 178 by the structural replication component 34 will be described in more detail. At step 179, the structural replication manager 38 of the structural replication component 34 receives the schema differences identified at step 160. At step 180, the structural replication manager 38 identifies the type of each schema difference received at step 179. In other words, the structural replication manager 38 identifies the type of structural changes that needs to be made to the target database 28. A variety of structural differences can exist between the source and target databases 24, 28 and, accordingly, a variety of structural changes can be made to the target database to bring the target database 28 into agreement with the source database 24. For example, some of these structural changes include, but are not limited to, creating an entirely new table, adding columns to existing tables, deleting columns from existing tables, etc. Each of the possible structural changes is a different type of schema difference. Once the structural replication manager 38 identifies the types of schema differences, the structural replication manager 38 invokes a method or class for each schema difference at step 181. The method that is invoked for each schema difference is dependent on the type of schema difference. In other words, the methods that are ultimately invoked depend on the type of structural change that needs to be performed to the target database 28. The structural replication manager 38 utilizes the methods to construct a dynamic structural statement 41 at step 182. The dynamic structural statement 41 is capable of performing the necessary structural changes to the target database 28. The structural statement 41 is dynamic because it is able to accommodate the various types of structural changes that are required to be performed and able to perform the various structural changes to the target database 28. At step 183, the structural replication manager 38 applies the dynamic structural statement 41 to the target database 28 to make the structural changes to the target database 28.

Referring again to FIG. 10, after the structural replication component 34 performs the structural replication at step 178, the structural replication component 34 performs a check process (step 184) to determine if all the identified structural changes were made to the target database 28 and to determine if any structural differences between the source database 24 and the target database 28 still exist.

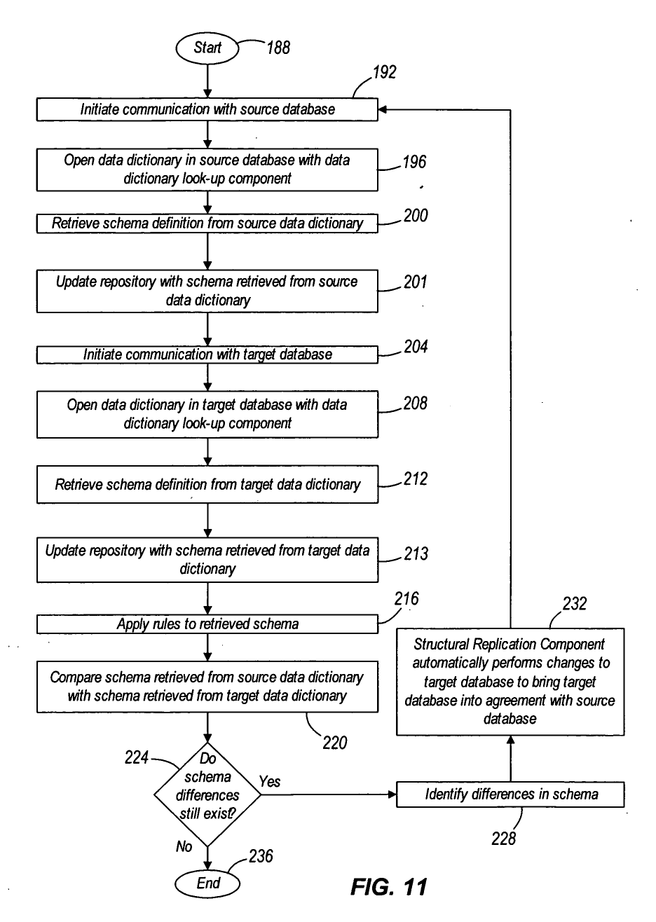

Referring now to FIG. 11, the check process performed at step 184 (see FIG. 10) by the structural replication component 34 is illustrated in more detail. The structural replication component 34 begins the check process at step 188 and initiates communication with the source database 24 at step 192. At step 196, the data dictionary look-up component 39 opens the data dictionary 129 in the source database 24 and the structural replication component 34 retrieves the schema definition from the source data dictionary 129 at step 200. At step 201, the structural replication component 34 updates the repository 36 with the retrieved schema 110 from the source database 24. The structural replication component 34 initiates communication with the target database 28 at step 204 and the data dictionary look-up component 39 opens the data dictionary in the target database 28 at step 208. At step 212, the structural replication component 34 retrieves the schema definition from the target data dictionary 147 and updates the repository 36 with the schema 110 retrieved from the target database at step 213. The structural replication component 34 applies the rules 107 to the retrieved schema 110 in the repository 36 at step 216 to refine the retrieved schema as desired by a user. In some embodiments, the rules 107 applied at step 216 may be the same rules applied at step 152 of the structural replication process.

At step 220, the structural replication component 34 compares the schema retrieved from the source and target databases 24, 28 to identify any schema or structural differences that may exist. At step 224, the structural replication component 34 determines if any differences still exist between the source database schema and the target database schema after the structural replication component 34 preformed the first structural replication at step 178. If schema differences do still exist between the source and target databases 24, 28, the structural replication component 34 identifies the schema differences at step 228 and the structural replication component 34 again automatically performs structural replication at step 232 to make the structural changes to the target database 28 to bring the structure of the target database 28 into agreement with the structure of the source database 24. Similar to the first time the structural replication component 34 performed structural replication, the structural replication component 34 again performs structural replication without any interaction from a user. After step 232, the structural replication process loops back to step 192 and the structural replication component 34 again performs the check process steps 192-220 until once again reaching step 224 where the structural replication component 34 again determines if any schema differences exist between the source and target databases 24, 28. This loop continues as long as schema differences exist between the source and target databases 24, 28. At any time the repository refresh process is at step 224 (i.e., either on the first pass through the check process or on any subsequent pass through the check process) and no schema differences exist between the source and target databases 24, 28, the structural replication component 34 ends the check process at step 236. At the conclusion of the check process at step 236, the structural replication process proceeds to step 240 in FIG. 10.

Referring now to FIG. 10 and step 240, the structural replication component 34 refreshes the repository 36 with the structural changes made by the structural replication component 34 during structural replication. At step 241, the structural replication component 34 generates the structure of the queue based on the structural differences identified and updated in the repository 36. As described above, the queue 80 needs to have the same structure as the source and target databases 24, 28 in order to be able to accommodate the data replication that will be occurring later. Accordingly, the structural replication component 34 looks in the repository 36 to see what structural changes were made to the source database 24 and will be made to the target database 28, and makes the structural changes to the queue 80. At step 242, the structural replication component composes an activity report that will include the structural changes performed during the structural replication process. At step 244, the structural replication component 34 sends the activity report to an output. The activity report can be sent in a variety of formats including, but not limited to, email, SNMP trap, etc., and includes the structural changes performed by the structural replication component 34 during automated structural replication. In some embodiments, the output to which the activity report is sent can be a programmer, data architect, database administrator, other users, or a database for storage. After the activity report is sent, the structural replication component 34 ends the structural replication process at step 248.

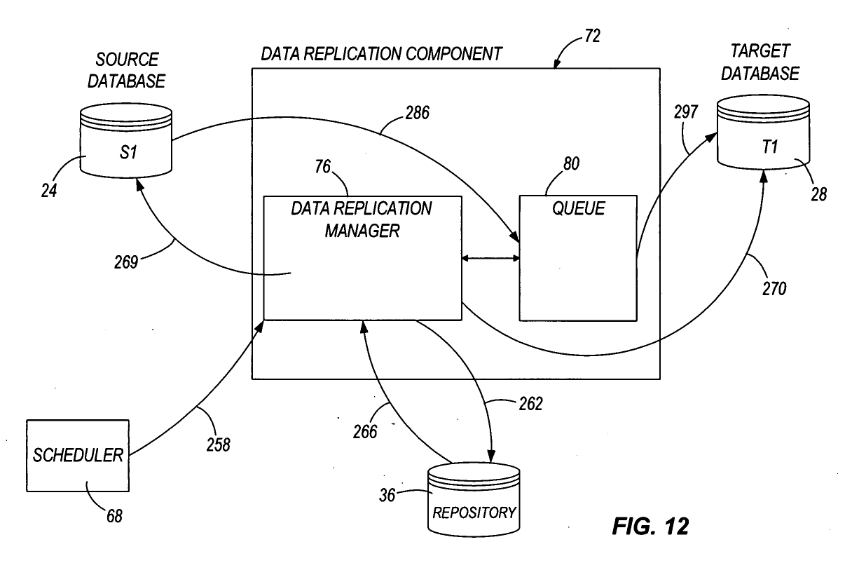

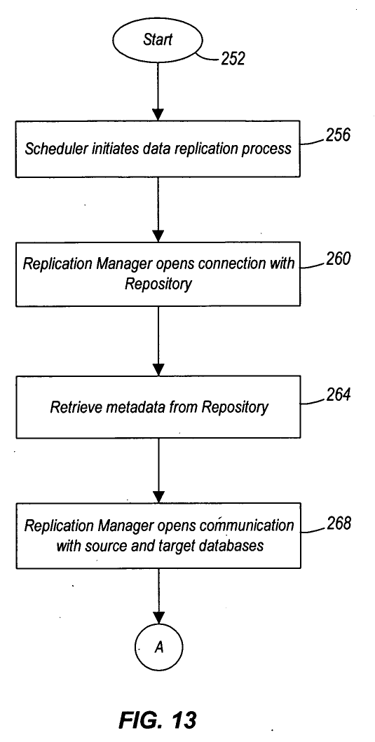

Referring now to FIG. 12, a general system diagram illustrating an exemplary data replication process performed with the data replication component 72 is provided. In addition to FIG. 12, reference is also made to FIGS. 13-16 which are flowcharts identifying steps of the data replication process performed by the data replication component 72. The data replication component 72 may, for example, perform the data replication process on all source databases 24 and target databases 28. The data replication component 72 is responsible for identifying the data changes that have occurred to the source databases 24 and replicating the data (or making the data changes) to the target databases 28. In other words, the data replication component 72 identifies the data differences between the source databases 24 and the target databases 28 and makes those changes to the target databases 28 so the source and target databases 24, 28 are in agreement. The data replication component 72 interacts similarly with each set of source and target databases 24, 28. Accordingly, the data replication component 72 and data replication process will be described herein with respect to only one set of corresponding source and target databases 24, 28.

With particular reference to FIGS. 12 and 13, the data replication component 72 begins the data replication process at step 252. At step 256, the scheduler 68 initiates a data replication process by communicating with the replication manager 76 of the data replication component 72 as identified by arrow 258 in FIG. 12. The scheduler 68 can be set to initiate a data replication process at any time interval. For example, the scheduler 68 can be set to initiate a data replication process every second, hour, month, year, or any other time interval in between those listed or any time interval greater than a year. Alternatively, the scheduler 68 can initiate data replication on a real-time basis. That is, the scheduler 68 initiates a data replication process instantly each time a source database 24 receives new, modified, or deleted data to replicate the data to the target database 28. In such an alternative, a scheduler 68 may not be required. Instead, the data replication component 72 will detect when a data change has occurred in the source database 24 and automatically begins the data replication process upon detection of the data change.

At step 260, the data replication component 72 opens a connection with the repository 36 via the replication manager 76 as represented by arrow 262 and retrieves metadata 109 from the repository 36 at step 264 as represented by arrow 266. The metadata 109 contains valuable information such as, for example, database name, hostname/IP, database type, username and password to connect to the database, etc., and is used to form dynamic queries (described in greater detail below). At step 268, the data replication component 72 opens communication with the source and target databases 24, 28 via the replication manager 76 as respectively represented by arrows 269 and 270. The data replication process then proceeds to A.

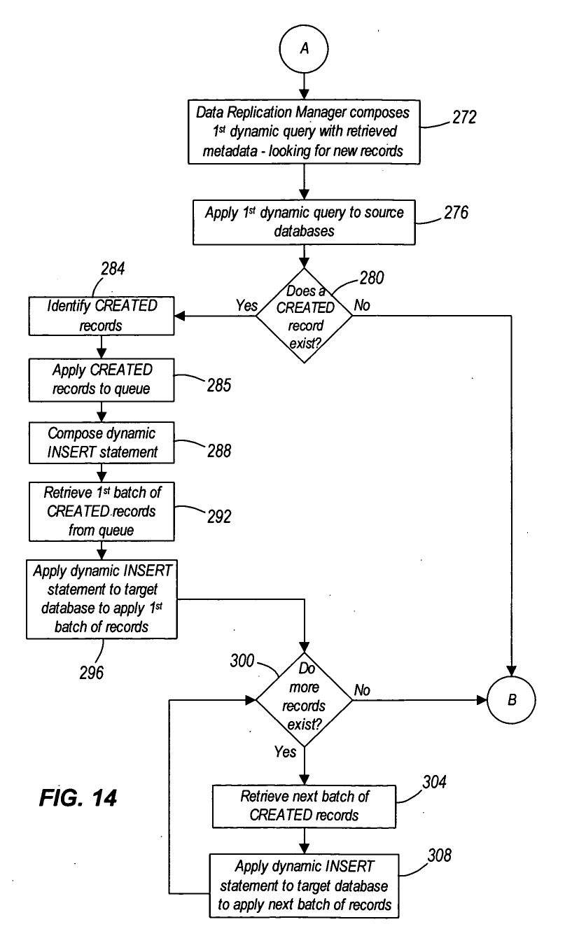

Referring now to FIG. 14 and step 272, the data replication component 72 composes a first dynamic query 265 (see FIG. 6) with the metadata 109 retrieved from the repository 36 at step 264. The data replication component 72 composes the first query 265 to look for new data records in the source database 24. The first query 265 is dynamic in order to accommodate the varying sizes and types of tables present in the source database 24. At step 276, the data replication component 72 applies the first dynamic query 265 to the source database 24 to look for new data records. Since the first query 265 is dynamic, the first query 265 is compatible with all of the different tables within the source database 24 to identify the new records. At step 280, the data replication component 72 determines if any new or created records exist in the source database 24. If no created records exist, the data replication component 72 proceeds to B. If created records do exist, the data replication component 72 proceeds to step 284 where the data replication component 72 identifies the created records. At step 285, the data replication component 72 applies the identified created records to the queue 80 (as represented by arrow 286 in FIG. 12) to await replication. At step 288, the data replication component 72 composes a dynamic data element or dynamic insert statement 289 (see FIG. 6), which is capable of inserting the identified created records into the target database 28 from the queue 80. The insert statement 289 is dynamic for at least a couple reasons. First, the insert statement 289 is dynamic in order to accommodate the varying types of target databases 28 and the varying sizes of the tables within the target databases 28. For example, tables within a single target database 28 vary significantly in size and format, and the insert statement 289 is required to create or insert the new data record into the tables no matter the size and format of the table. Secondly, the insert statement 289 is dynamic to accommodate the different types of data changes that will be made to the target database 28.

With continued reference to FIG. 14, the data replication component 72 retrieves a first batch of the created records at step 292 that were identified at step 284. In the illustrated embodiment, the data replication component 72 retrieves and replicates data records in batches, and such batches can comprise any number of records. For example, a single batch of records can comprise 20,000 records. In such an example, the data replication component 72 retrieves 20,000 created records at a time. Alternatively, the data replication component 72 retrieves and replicates all records at once without batching. At step 296, the data replication component 72 applies the dynamic insert statement 289 to the target database 28 to apply the first batch of created records from the queue 80 to the target database 28 as represented by arrow 297 in FIG. 12. In other words, the dynamic insert statement 289 adds the first batch of new data records to the appropriate tables in the target database 28. At step 300, the data replication component 72 determines if more created records exist that were not retrieved in the first batch. If the number of created records is greater than the batch size, then created records will still exist and the data replication component 72 will proceed to step 304 where the next batch of created records is retrieved. At step 308, the data replication component 72 again applies the dynamic insert statement 289 to the target database 28 to apply the next batch of created records from the queue 80 to the target database 28. The data replication component 72 then loops the data replication process back to step 300 to again determine if more created records still exist. This loop from step 300 to step 308 continues until all created records are applied to the target database 28. At any time the data replication component 72 is at step 300 (i.e., either on the first pass or on any subsequent pass) and no created records exist, the data replication component 72 proceeds to B.

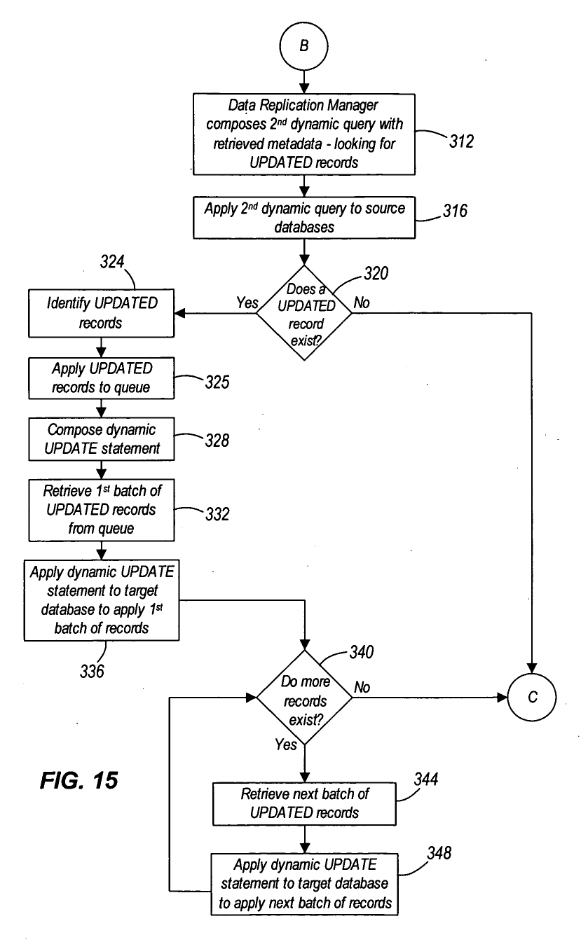

Referring now to FIG. 15, the data replication component 72 proceeds to step 312 where the data replication component 72 composes a second dynamic query 265 (see FIG. 6) with the metadata 109 retrieved at step 264. The second dynamic query 265 is intended to look for modified or updated data records in the source database 24. The second query 265 is dynamic for similar reasons as the first dynamic query 265. At step 316, the data replication component 72 applies the second dynamic query 265 to the source database 24 to look for updated data records. At step 320, the data replication component 72 determines if any updated records exist in the source database 24. If no updated records exist, the data replication component 72 proceeds to C. If updated records do exist, the data replication component 72 proceeds to step 324 where the data replication component 72 identifies the updated records. At step 325, the data replication component 72 applies the identified updated records to the queue 80 (as represented by arrow 286 in FIG. 12) to await replication. At step 328, the data replication component 72 composes a dynamic data element or dynamic update statement 289 (see FIG. 6), which is capable of updating the appropriate data records in the target database 28 from the queue 80. The update statement 289 is dynamic for similar reasons as the dynamic insert statement 289.

With continued reference to FIG. 15, the data replication component 72 retrieves a first batch of the updated records at step 332 that were identified at step 324. The updated records are batched in a similar manner to the created records described above. Also, the alternatives described above in connection with the created records also apply to the updated records. At step 336, the data replication component 72 applies the dynamic update statement 289 to the target database 28 to apply the first batch of updated records from the queue 80 to the target database 28 as represented by arrow 297 in FIG. 12. In other words, the dynamic update statement 289 modifies the data records present in the target database 28 with the updated data records identified at step 324. At step 340, the data replication component 72 determines if more updated records exist that were not retrieved in the first batch. If the number of updated records is greater than the batch size, then updated records will still exist and the data replication component 72 will proceed to step 344 where the next batch of updated records is retrieved from the queue 80. At step 348, the data replication component 72 again applies the dynamic update statement 289 to the target database 28 to apply the next batch of updated records from the queue 80 to the target database 28. The data replication component 72 then loops back to step 340 to again determine if more updated records still exist. This loop from step 340 to step 348 continues until the data replication component 72 applies all updated records to the target database 28. At any time the data replication component 72 is at step 340 (i.e., either on the first pass or on any subsequent pass) and no updated records exist, the data replication component 72 proceeds to C.

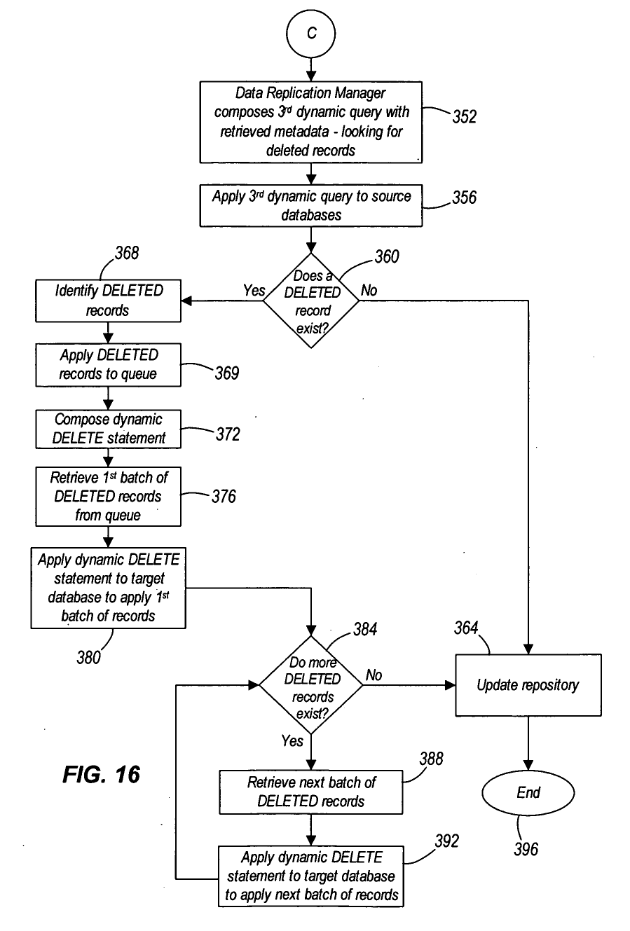

Referring now to FIG. 16, the data replication component 72 proceeds to step 352 where the data replication component 72 composes a third dynamic query 265 with the metadata 109 retrieved at step 264. The third dynamic query 265 is intended to look for deleted data records in the source database 24. The third query 265 is dynamic for similar reasons as the first and second dynamic queries. At step 356, the data replication component 72 applies the third dynamic query 265 to the deleted records table 98 of the source database 24 to look for deleted data records. At step 360, the data replication component 72 determines if any deleted data records exist in the source database 24. If no deleted data records exist, the data replication component 72 proceeds to step 364 where the data replication component 72 updates the repository 36 with the current state of the data records. If deleted records do exist, the data replication component 72 proceeds to step 368 where the data replication component 72 identifies the deleted records. At step 369, the data replication component 72 applies the identified deleted records to the queue 80 (as represented by arrow 286 in FIG. 12) to await replication. At step 372, the data replication component 72 composes a dynamic data element or dynamic delete statement 289, which is capable of deleting the appropriate data records in the target database 28. The delete statement 289 is dynamic for similar reasons as the dynamic insert and update statements 289.

With continued reference to FIG. 16, the data replication component 72 retrieves a first batch of the deleted records at step 376 from the queue 80. The deleted records are batched in a similar manner to the created and updated records. Also, the alternatives described above in connection with the created and updated records also apply to the deleted records. At step 380, the data replication component 72 applies the dynamic delete statement 289 to the target database 28 to delete the first batch of deleted records in the queue 80 from the target database 28. In some embodiments, the records to be deleted are completely deleted from the target database 28. In other embodiments, the records to be deleted are not actually deleted. Instead, the records to be deleted are maintained in the target database 28 and the data replication component 72 populates the “deleted time stamp” columns 102 of the associated target database tables with the date on which the records were deleted. Maintaining the deleted records in the target database 28 ensures that the data will not be lost permanently and is valuable in the event the data records need to be restored. At step 384, the data replication component 72 determines if more deleted records exist in the queue 80 that were not retrieved in the first batch. If the number of deleted records is greater than the batch size, then deleted records will still exist and the data replication component 72 will proceed to step 388 where the next batch of deleted records is retrieved from the queue 80. At step 392, the data replication component 72 again applies the dynamic delete statement 289 to the target database 28 to delete the next batch of deleted records from the target database 28. The data replication component 72 then loops back to step 384 to again determine if more deleted records still exist. This loop from steps 384 to step 392 continues until all deleted records are applied to the target database 28. At any time the data replication component 72 is at step 384 (i.e., either on the first pass or on any subsequent pass) and no deleted records exist, the data replication component 72 proceeds to step 364 where the data replication component 72 updates the repository 36 with the current state of the data records. At step 396, the data replication component 72 ends the data replication process.

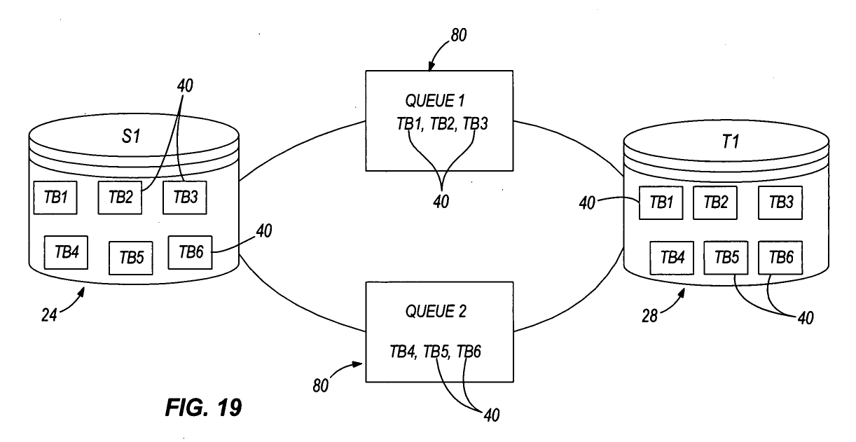

With reference to FIG. 19, another feature of the replication system is illustrated and relates to the queue 80. In some instances, mass quantities of data require replication from the source database 24 to the target database 28. The mass quantities of data are located in a variety of tables 40 (TB1-TB6) in the source database 24 and the data must be replicated to associated tables 40 (TB1-TB6) in the target database 28. In order to provide a more efficient data replication process, the data replication component 72 may employ a plurality of queues 80 to replicate the data. The plurality of queues 80 replicate their portions of the data in parallel to each other, which is more efficient than a single queue 80 replicating all of the data in series. In the example illustrated in FIG. 19, two queues 80 are illustrated, however, it should be understood that the data replication component 72 can employ any number of queues 80 to replicate data from the source database to the target database.

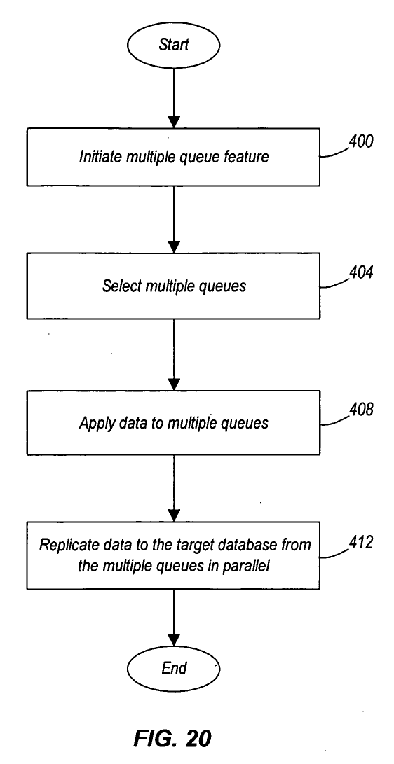

Referring now to FIG. 20, an exemplary flowchart illustrating steps of a portion of the data replication process associated with the feature illustrated in FIG. 19. At step 400, the multiple queue feature is initiated. In some embodiments, the multiple queue feature may be manually initiated by a user. In other embodiments, the multiple queue feature may be initiated by the data replication component 72 of the replication system 32. At step 404, the data replication component 72 selects the number of queues desired for data replication. While only two queues 80 are illustrated in FIG. 19, any number of queues 80 can be utilized for replicating data from the source database 24 to the target database 28. The data replication component 72 applies the data to be replicated to the queues 80. The data replication component 72 can apply the data to the queues 80 in any desired manner. For example, the data may be split proportionally among the queues (e.g., in-half if two queues 80 utilized or evenly amongst queues if more than two are utilized) or certain data or tables may be allocated to a certain queue 80. In the example illustrated in FIG. 19, half of the tables (TB1, TB2, TB3) are applied to Queue #1 and half of the tables (TB4, TB5, TB6) are applied to Queue #2. At step 412, the data replication component 72 replicates the data from the queues 80 in parallel to the target database 28. In other words and with reference to the illustrated example in FIG. 19, Queue #1 and Queue #2 are both simultaneously replicating data to the target database 28. As indicated above, utilizing multiple queues 80 to replicate data improves the efficiency of the data replication process.

While the above example is illustrated and described with only one set of source and target databases 24, 28, it should be understood that the multiple queues 80 illustrated in FIG. 19 may also receive data from more than one source database 24 and may also replicate data to more than one target database 28. In such an alternative, the queue will received data from multiple source databases 24 and replicate data to multiple target databases 28.

It should also be understood that the multiple queue feature describe herein may be utilized in the replication of any type of data. For example, this multiple queue feature may be utilized to replicate newly created data, updated data, and deleted data from the source databases 24 to the target databases 28.

It should further be understood that the data replication component may perform the data replication process with more or fewer steps, and in different manners than that illustrated and described herein, thereby requiring different steps than those illustrated and described. For example, the data replication component can replicate the created, updated, and deleted records in different orders than that illustrated and described.

In addition, it should be understood that the queries applied to the source databases may not be required to be dynamic. Such instances may arise when the elements or tables to which the queries are applied are static with respect to each other (i.e., the elements or tables all have the same structure). For example, the deleted records table in each of the source databases may have the same structure in all databases. Accordingly, the third query applied to the deleted records table to identify deleted records may not be required to be dynamic.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention. It is intended that the scope of the invention not be limited by the specification, but be defined by the claims set forth below.

What is claimed is:

1. A database management system, comprising:
a first source database comprising a first type of database, the first source database including structure and data, the structure comprising a first table and the data comprising a first data record in the first table;
a second source database comprising a second type of database different than the first type of database, the second source database including structure and data, the structure comprising a second table and the data comprising a second data record in the second table;
a target database; and
a replication system including at least one of a structural replication component adapted to replicate structure and a data replication component adapted to replicate data;
wherein the replication system is operable to replicate at least one of structure and data from either the first source database or the second source database to the target database.

2. The database management system of claim 1, wherein the replication system includes both the structural replication component and the data replication component and is operable to replicate both structure and data from either the first source database or the second source database to the target database.

3. The database management system of claim 1, wherein the target database comprises any one of the first type of database, the second type of database, or a third type of database, the third type of database being different than both the first and second types of databases, and wherein the replication system is operable to replicate at least one of structure and data from either the first source database or the second source database to the target database when the target database is any one of the first type of database, the second type of database, or the third type of database.

4. A database management system, comprising:
a source database comprising one of a plurality of source database types, the source database including structure and data, the structure comprising a table and the data comprising a data record in the table;
a target database comprising one of a plurality of target database types; and
a replication system including at least one of a structural replication component adapted to replicate structure and a data replication component adapted to replicate data;
wherein the replication system communicates with the source database when the source database is any one of the plurality of source database types and communicates with the target database when the target database is any one of the plurality of target database types to replicate at least one of structure and data from the source database to the target database.

5. The database management system of claim 4, wherein the replication system includes both the structural replication component and the data replication component and is operable to replicate both structure and data from the source database to the target database.

6. A database management system, comprising:
a source database including source structure and source data, the source structure comprising a first table having a first configuration and a second table having a second configuration different than the first configuration, the source data comprising a first data record in the first table and a second data record in the second table;
a target database; and
a replication system including a data replication component adapted to identify both the first and second data records from the first and second tables having different configurations and replicate the first and second data records to the target database.

7. The database management system of claim 6, wherein the data replication component composes a query adapted to communicate with both the first table having the first configuration and the second table having the second configuration, and wherein the data replication component applies the query to the first and second tables to identify the first and second data records.

8. The database management system of claim 7, wherein the first and second data records are newly created data records and the query is adapted to identify newly created data records, and wherein the data replication component applies the query to the first and second tables to identify the newly created first and second data records.

9. The database management system of claim 7, wherein the first and second data records are updated data records and the query is adapted to identify updated data records, and wherein the data replication component applies the query to the first and second tables to identify the updated first and second data records.

10. The database management system of claim 7, wherein the first and second data records are deleted data records and the query is adapted to identify deleted data records, and wherein the data replication component applies the query to the first and second tables to identify the deleted first data record and the deleted second data record.

11. The database management system of claim 6, wherein the target database includes target structure, the target structure comprising a first target table having the first configuration and a second target table having the second configuration, wherein the data replication component composes a data element and applies the data element to the first and second target tables having different configurations to replicate the first data record to the first target table and the second data record to the second target table.

12. The database management system of claim 11, wherein the first and second data records are newly created data records and the data element is an insert element for replicating newly created data records to the target database, wherein the data replication component applies the insert element to the first and second target tables having different configurations to replicate the newly created first data record to the first target table and replicate the newly created second data record to the second target table.

13. The database management system of claim 11, wherein the first and second data records are updated data records and the data element is an update element for replicating updated data records to the target database, wherein the data replication component applies the update element to the first and second target tables having different configurations to replicate the updated first data record to the first target table and replicate the updated second data record to the second target table.

14. The database management system of claim 11, wherein the first and second data records are deleted data records and the data element is a delete element for replicating deleted data records to the target database, wherein the data replication component applies the delete element to the first and second target tables having different configurations to replicate the deleted first data record to the first target table and replicate the deleted second data record to the second target table.

15. The database management system of claim 14, wherein the first data record and the second data record are completely deleted from the first and second target tables upon replication to the target database.

16. The database management system of claim 14, wherein the first and second target tables each include a deleted time stamp column, and wherein the first and second data records remain in the first and second target tables after replication and the deleted time stamp column in each of the first and second target tables is populated with a time associated with completion of replication.

17. The database management system of claim 6, wherein the first and second data records are two of a plurality of data records in the source data, and wherein the data replication component replicates the plurality of data records to the target database in batches.

18. The database management system of claim 6, wherein the replication system further comprises a scheduler in communication with the data replication component, and wherein the scheduler communicates with the data replication component to initiate the data replication component.

19. The database management system of claim 6, wherein the data replication component is initiated by a user.

20. A database management system, comprising:
a source database including source data;
a target database including target data, wherein a difference in data exists between the source data and the target data, wherein the difference in data is one type of a plurality of types of differences; and
a replication system including a data replication component adapted to create a data element based on the type of difference in data between the source data and the target data;
wherein the data replication component applies the data element to the target database to change the target data such that the difference in data no longer exists between the source data and the target data.

21. The database management system of claim 20, wherein the data replication component is adapted to create the data element differently depending on the type of difference in data.

22. The database management system of claim 20, wherein the difference in data comprises a newly created data record in the source data that is not present in the target data, and wherein the data element is a data insert element for inserting the newly created data record into the target data so the difference in data no longer exists between the source data and the target data.

23. The database management system of claim 20, wherein the difference in data comprises an updated data record in the source data that has not been updated in the target data, and wherein the data element is a data update element for updating the target data with the updated data record so the difference in data no longer exists between the source data and the target data.

24. The database management system of claim 20, wherein the difference in data comprises a deleted data record in the source data that is not deleted from the target data, and wherein the data element is a data delete element for deleting the deleted data record from the target data so the difference in data no longer exists between the source data and the target data.

25. The database management system of claim 20, wherein the difference in data comprises one of
(a) a newly created data record in the source data that is not present in the target data,
(b) an updated data record in the source data that has not been updated in the target data, or
(c) a deleted data record in the source data that is not deleted from the target data; and
wherein the data element comprises one of
(i) a data insert element if the difference in data is a newly created data record for inserting the newly created data record into the target data so the difference in data no longer exists between the source data and the target data,
(ii) a data update element if the difference in data is an updated data record for updating the target data with the updated data record so the difference in data no longer exists between the source data and the target data, or
(iii) a data delete element if the difference in data is a deleted data record for deleting the deleted data record from the target data so the difference in data no longer exists between the source data and the target data; and
wherein the data insert element, the data update element, and the data delete element are all different.

26. The database management system of claim 20, wherein the difference in data is one of a plurality of differences in data between the source data and the target data, and wherein the data replication component creates the data element such that, when applied to the target database, the data element is adapted to make changes to the target data so that none of the plurality of differences in data exist between the source data and the target data.

27. The database management system of claim 26, wherein the changes to the target data are made in batches.

28. The database management system of claim 20, wherein the replication system further comprises a scheduler in communication with the data replication component, and wherein the scheduler communicates with the data replication component to initiate the data replication component.

29. The database management system of claim 20, wherein the data replication component is initiated by a user.
